(19) United States
(12) Patent Application Publication
(10) Pub. No.: US 2003/0046408 A1
(43) Pub. Date: Mar. 6, 2003

(54) Method and system for handling computer resource requests on a monetary priority basis

(76) Inventors: Jeffrey Scott Weaver, Fort Collins, CO (US); David Joe Luman, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/943,392

(22) Filed: Aug. 30, 2001

(51) Int. Cl. G06F 15/16; G06F 9/00

(52) U.S. Cl. 709/229

(57) ABSTRACT

A method of handling resource requests on priority basis. The method comprising receiving a resource request from a preferred subscriber having a monetary priority designation and processing the job request from the preferred subscriber prior to processing other job requests from non-preferred subscribers having a non-priority designation.

A resource request handling system comprising at least one preferred subscriber, at least one non-preferred subscriber, and a throughput resource. The preferred subscriber has a monetary priority designation and the non-preferred subscriber has a non-monetary priority designation. The throughput resource has a priority scheduling queue configured for handling resource requests of the preferred subscriber prior to handling resource requests of the non-preferred subscribers.

### THE FIELD OF THE INVENTION

The present invention is generally related to handing computer resource requests and in particular, handling computer resource requests on a monetary priority basis.

### BACKGROUND OF THE INVENTION

The law of supply and demand governs allocation of resources and their cost. In the world of computers and communications, internet resources are in high demand, and sometimes short supply. One example of this principle is played out between computer users and internet service providers (ISPs). Internet service providers assist computer users in connecting to the internet network of communications and resources. However, the computer user must first get access to the ISP by dialing in to the ISP by modem or through a local area network (LAN). Either way, the ISP has a limited number of modems to permit access to the ISP for computer users. In addition, the ISP has a limited amount of access to deeper internet resources such as wide area networks, routers, internet trunk lines, etc. Accordingly, ISPs partially regulate allocation of these resources among users by charging fees for use of the resources. Computer users that pay a fee for a premium subscription to the ISP typically are offered more modems to access the ISP, unlimited time usage of internet access, more storage from the ISP, etc.

Nevertheless, even computer users with premium subscriptions to ISPs end up waiting in line for their requests to be fulfilled along with the millions of other computers users on the internet. Accordingly, these premium subscribers experience a hurry up and wait scenario in which they pay extra money to get on the internet faster and are able to use it as long as they want, but still have to slog through high volume traffic at their ISP site, email services, and/or their service provider site (e.g. on-line stock trader). This hurry and up wait scenario takes place because once the computer user is on-line, all the requests made by the users to the ISP are handled in a queue on a first-in-first-out (FIFO) basis. Accordingly, the premium subscribers end up waiting in the same lines, i.e. queues, as non-premium subscribers to get their job requests fulfilled.

These sorts of problems are not limited just to relationships between computer users and ISPs. Rather these problems are faced by participants in most network environments, both public and private.

Accordingly, with computer users willing to pay additional money to harness limited computer resources, and the increasing number of users on networks such as the internet, additional systems and methods for allocating network resources, such as the internet, are desirable.

### SUMMARY OF THE INVENTION

A method of handling resource requests on priority basis, according to one embodiment of the present invention includes receiving a resource request from a preferred subscriber having a monetary priority designation and then processing the resource request from the preferred subscriber prior to processing resource requests from non-preferred subscribers.

A resource request handling system according to one embodiment of the present invention comprises at least one preferred subscriber, at least one non-preferred subscriber, and a throughput resource. The preferred subscriber has a monetary priority designation and the non-preferred subscriber has a non-monetary priority designation. The throughput resource has a priority scheduling queue configured for handling resource requests of the preferred subscriber prior to handling resource requests of the non-preferred subscribers.

### BRIEF DESCRIPTION OF THE DRAWINGS

FIG. 1 is a block diagram illustrating one exemplary embodiment of an monetary priority request handling system of the present invention.

FIG. 2 is a block diagram illustrating one exemplary embodiment of the present invention of a method of handling resource requests on monetary-priority basis.

FIG. 3 is a block diagram illustrating one exemplary embodiment of a monetary priority resource handling queue of the present invention.

FIG. 4 is a block diagram illustrating one exemplary embodiment of a multiple throughput resource system of the present invention.

FIG. 5 is block diagram illustrating one exemplary embodiment of a monetary priority subscription monitor of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the method and system of the present invention can be implemented in hardware via a microprocessor, programmable logic, or state machine, in firmware, or in software within a given device. Components of the present invention may also reside in software on one or more computer-readable mediums. The term computer-readable medium as used herein is defined to include any kind of memory, volatile or non-volatile (e.g., floppy disks, hard disks, CD-ROMs, flash memory, read-only memory (ROM), and random access memory (RAM)).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM or HPUX, available from Hewlett-Packard. In another embodiment, the operating system does not employ a windowing environment.

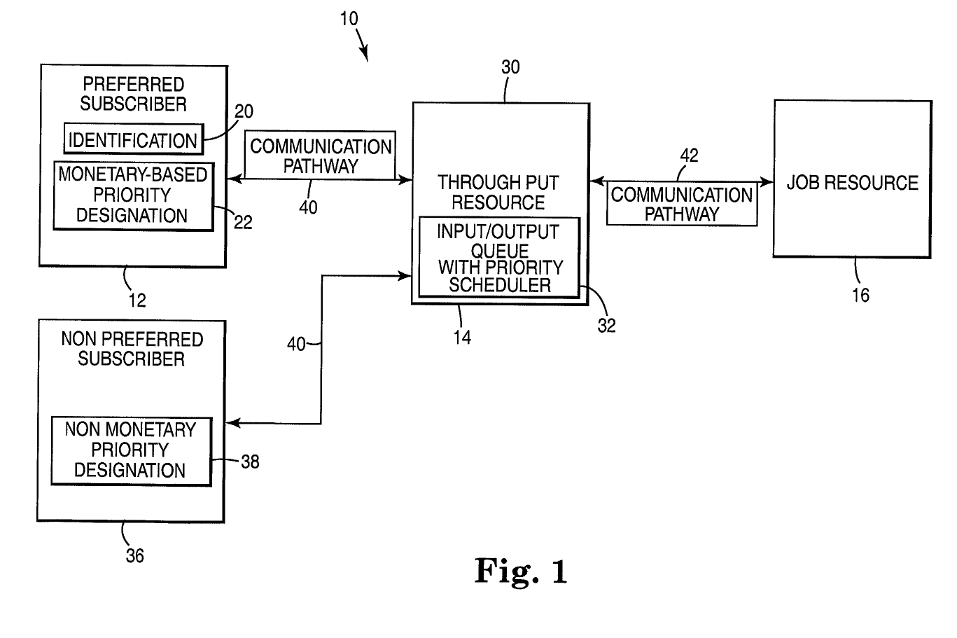

FIG. 1 illustrates an exemplary embodiment of system 10 according to the present invention. System 10 includes preferred subscriber 12, throughput resource 14, and job resource 16. Preferred subscriber 12 includes identification 20 and monetary-based priority designation 22 while throughput resource 14 includes input/output priority scheduler queue 30. Non-preferred subscriber 36 includes the same features as subscriber 12 except having non-monetary priority designation 38 instead of monetary priority designation 22.

First communication pathway 40 conveys input requests, and outputs from those input requests, between subscriber 12 and throughput resource 14. Second communication pathway 42 conveys input requests, and outputs from those input requests, between throughput resource 14 and job resource 16. First and second communication pathways 40,42 preferably comprise a network communication link, as used herein, that includes an Internet communication link, an intranet communication link, similar high-speed communication link, and/or a telecommunication link. In some cases, communication pathways 40,42 can be as simple as a phone line/modem hookup as occurs with dial-in access between users and ISPs.

Subscriber 12 is a computing resource that requests a service or product from another computer resource. A computer resource comprises a microprocessor based workstation, server, or other device having a controller and memory for performing logic and sequence operations, and that is capable of communication with other similarly equipped devices. Identification 20 of subscribers 12 includes an identifier such as an IP address, uniform resource locator (URL), machine name, user name etc. by which subscriber 12 is uniquely identified to other computer resources.

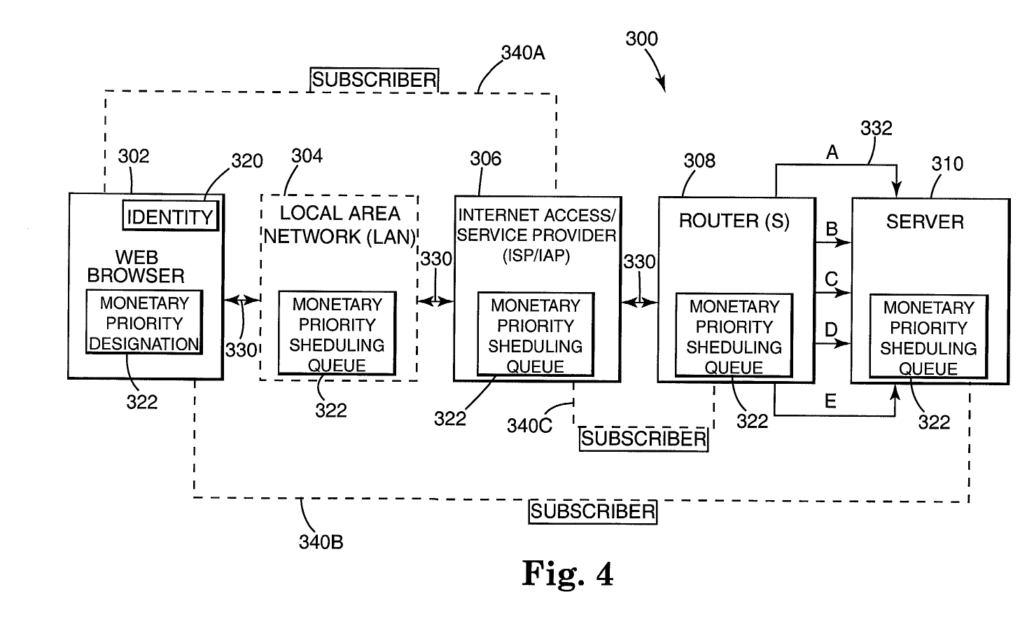

Throughput resource 14 is a computer resource that either fulfills the request from subscriber 12 or passes the request along to another computer resource, such as job resource 16. Fulfilling the request can be as simple as transmitting the request from throughput resource 14 to job resource 16, or as complicated as throughput resource 14 providing web hosting services, application service provider services, granting internet access, providing email service, routing internet communications, etc. In other words, throughput resource 14 simply represents an entity to which a communication is sent and throughput resource 14 either passes the communication along to another entity or acts on that communication without passing the communication along to another entity. Moreover, multiple throughput resources 14 can be connected in series, as will be further described in association with FIG. 4. In that scenario, a throughput resource that passes along a communication to another entity, such as job resource 16, can become a subscriber and job resource 16 can then act as a throughput resource that acts on the communication or passes along the communication to yet another entity.

In each case, money plays a primary role between subscriber 12 and throughput resource 16. Subscriber 12 establishes a monetary relationship, such as a contract or one time payment, with throughput resource 14 to receive better service from throughput resource 14 than if subscriber did not have that monetary relationship. Throughput resource 14 uses input/output scheduler queue 30 to give subscriber 12 priority treatment based on the monetary relationship. Preferred subscribers 12 are identified by their monetary priority designation 22.

Input/output scheduler queue 30 of throughput resource 14 comprises a queue that handles requests for input to, and output from, throughput resource 14. Queue 30 includes a scheduler that orders input/output requests on a monetary priority basis. Input/output requests from preferred subscribers having monetary priority designation 22 are placed higher in the queue relative to non-preferred subscribers which have a non-monetary priority designation. Simply stated, those subscribers 12 that pay money to throughput resource 14 receive priority treatment in queue 30, i.e. get their input/output requests processed faster, over subscribers that do not pay money to throughput resource 14.

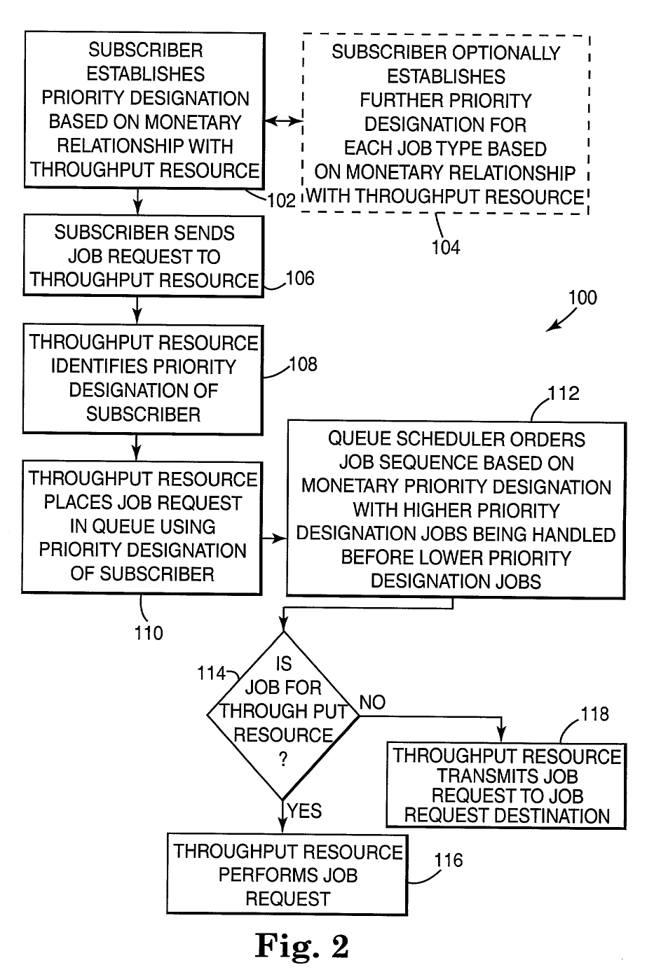

As shown in FIG. 2, method 100 of the present invention for handling resource requests on a monetary priority basis with system 10 includes first step 102 in which subscriber 12 establishes monetary priority designation 22 based on a monetary relationship with throughput resource 14. Step 102 optionally includes further step 104 in which subscriber 12 optionally establishes a further monetary priority designation for each type of job request to be made to throughput resource 14. Next, subscriber 12 sends a job request to throughput resource 14 (step 106). Throughput resource 14 then identifies the priority designation of subscriber 12 (step 108) and then places the job request in input/output scheduler queue 30 using monetary priority designation 22 of subscriber 12 (step 110). In step 112, queue 30 orders job requests on a monetary priority basis with higher priority designation jobs being handled before lower priority designation jobs.

Subscribers 12 receive higher priority designations by paying money to receive better service. Different tiers of service are optionally available in which subscribers 12 that pay the most money receive the best service and subscribers 12 that pay some money receive better service than non-payers but not as good as service as the top-paying subscribers. In this embodiment, receiving better service means that queue 30 does not follow the conventional first in first out (FIFO) model, but rather that queue 30 continually moves paying subscribers up in priority over non-paying and/or lower-paying subscribers.

For each job request, method 100 includes next step 114 which determines whether the job request is to be performed by throughput resource 14 or transmitted to job resource 16. If the job request is to be performed by throughput resource 14, then step 116 is taken in which throughput resource 14 performs the job request. If the job is for job resource 16, then throughput resource 14 merely acts as a communication conduit and transmits the job/resource request to job resource 16 (step 118).

Finally, as previously explained for system 10, throughput resource 14 can optionally act as a subscriber relative to job resource 16 with job resource 16 in turn, acting as a throughput resource.

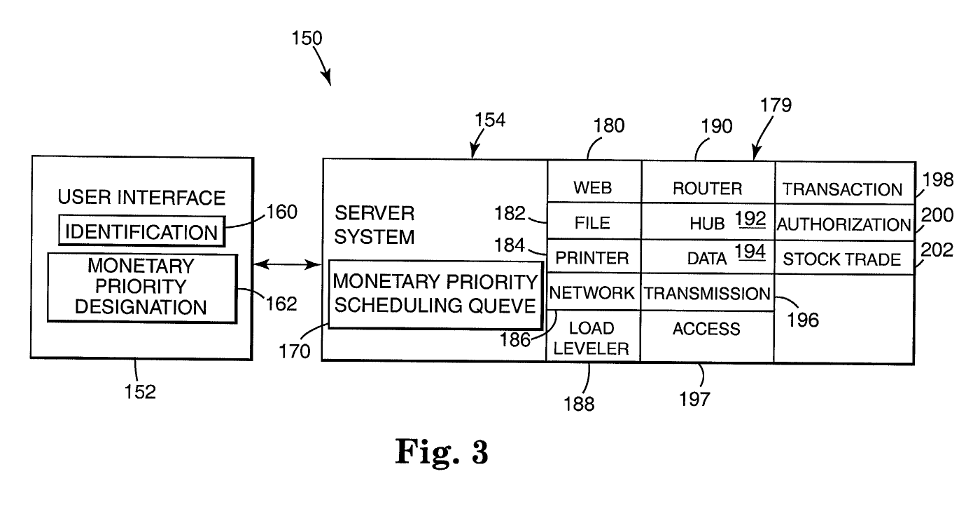

A system and method of the present invention for handling resource requests will now be described in further detail in association with FIG. 3 regarding which types of services and/or products can be handled on a monetary priority basis by a throughput resource and/or job resource. As shown in FIG. 3, system 150 includes user interface 152 and server system 154. User interface 152 includes identification 160 and monetary priority designation 162, and provides a mechanism for a subscriber to communicate with a throughput resource such as server system 154.

Server system 154 includes monetary priority scheduler queue 170 and comprises any one of the following resource types: web 180, file 182, printer 184, network 186, load leveler 188, router 190, hub 192, data 194, transmission 196, access 197, transaction 200, authorization 200, and stock trade 202. Simply put, these resource types comprise the types of jobs in which server system 154 can act as a throughput resource. Server system 154 acts as each selected resource type on a monetary priority basis using monetary priority scheduler queue 170 to handle requests so that preferred subscribers (such as user interfaces 152 (having a monetary priority designation) get their requests handled earlier or faster than those subscribers that pay no money or pay less money than the preferred subscribers.

For instance, web resource 180 includes server system 154 acting as a web site, internet search engine, or email service, etc. through which internet-based services are requested and received. With web resource 180, preferred subscribers get their output from internet requests (internet searchs, email, etc) quicker than non-preferred subscribers.

File resource 182 includes server system 154 acting as a file server on a monetary priority basis so that file requests (file access, modification, etc) made by preferred user interfaces are handled faster. Printer resource 184 includes server system 154 acting as a printer server to handle print requests on a monetary priority basis for preferred subscribers. Network resource 186 includes server system 154 acting as a network server to handle network function requests (communications) on a monetary priority basis for preferred subscribers. Load leveler resource 188, router resource 190, and hub resource 192 includes server system 154 acting as a load leveler, as a router, and as a hub, respectively, to distribute server loads, to select network routes, and to perform network hub operations on a monetary priority basis for preferred subscribers.

Data resource 194, transmission resource 186, and access resource 198 include server system 154 acting as a data retriever, as a communication transmitter, and a network access point (e.g. internet access provider), respectively, on a monetary priority basis for preferred subscribers. Finally, transaction resource 200, authorization resource 200, and stock trade resource 202 include server system 154 acting as a transaction medium, as an authorization point (e.g. credit card approval, security, etc), and as a stock trader, respectively, on a monetary priority basis for preferred subscribers.

A system and method of the present invention for handling resource requests on a monetary priority basis will now be further described in association with FIG. 4 regarding multiple relationships between subscribers and throughput resources, with particular attention directed to internet communications and resources. However, multiple subscriber-throughput resource relationships are not exclusively applicable to internet environments, but can be employed within other communication networks such as client-server networks, peer-to-peer networks, LANS, etc including both commercial and private networks.

As shown in FIG. 4, multiple subscriber-throughput resource system 300 comprises Web browser 302 and multiple throughput resources including local area network (LAN) 304, Internet access/service provider (ISP/IAP) 306, router(s) 308, and server 310. Web browser 302 includes identity 320 and monetary priority designation 322. LAN 304, ISP/IAP 306, router 308 and server 310 each include monetary priority scheduler queue 322 and also have communication pathway 330 extending between those respective resources. Communication pathways 330 have substantially the same features and attributes as communications pathways 40,42 of system 10. Between router 308 and server 310, communication pathway 330 further includes multiple alternate communication pathways 332A-E. Finally, system 300 includes a plurality of subscriber links 340 including subscriber link 340A between Web browser and ISP 306, subscriber link 340B between Web browser 302 and server 310, and subscriber link 340C between ISP 306 and router 308.

Each subscriber link 340 in system 300 represents a monetary contractual relationship between the resources at the ends of the link. Subscriber link 340 is not a separate communication pathway in system 300 but rather signifies a contractual relationship that is carried out along communication pathways 330.

For example, ISP/IAP 306 acts as a subscriber in a monetary relationship with router 308, which in turn acts as a throughput resource for ISP/IAP 306. This relationship allows ISP/IAP 306 to provide superior service to LAN 304 and/or web browser 302 since router 308 would give all requests from ISP/IAP 306 priority treatment over internet service/access providers that were not preferred subscribers. Router 308 would always select the fastest, most secure, and/or most stable route among routes 332A-332E for preferred ISP/IAP subscriber 306. This feature significantly gives preference to a whole group of communications and whole classes of users that use ISP/IAP 306 to speed their internet/network communication.

However, subscriber links are not limited to immediately adjacent computer resources within a communication chain or network. For example, Web browser 302 acts a subscriber in a monetary relationship with server 310, which in turn acts as a throughput resource (or job resource) for web browser 302. Server 310 acts as any one of multiple resource types, such as those resource types 179 identified with server system 154 (FIG. 3). One example of server 310 would be a financial services server in which financial transactions such as banking, loans, etc. are handled on a monetary priority basis for a subscriber, i.e. web browser 302, despite numerous intermediate throughput resources (e.g. LAN 304 and router 308) intervening between web browser 302 and server 310.

In another example, Web browser 302 acts a subscriber in a monetary relationship with ISP/IAP 306, which in turn acts as a throughput resource (or job resource) for web browser 302. In this arrangement, all requests (e.g, access, email, technical support, browsing, instant messaging, etc.) from web browser 302 are handled faster for preferred web browser 302 by ISP/IAP 306 than for non-preferred subscribers.

Finally, subscriber links are not limited to those shown in FIG. 4 but can include additional subscriber links formed between any desired combination of throughput resources and/or subscribers.

Although LAN 304, ISP/IAP 306, router(s) 308, and server 310 are shown in FIG. 4 with monetary priority scheduler queue 322, this feature does not necessitate that they each always act as a throughput resource in which queue 322 is always active. Rather monetary priority scheduler queue 322 optionally can be deactivated in favor of a more conventional FIFO queue. Moreover, no preference is given to a subscriber unless a monetary contractual relationship is established with the selected throughput resource. Accordingly, the mere existence of monetary priority scheduler queue 322 within a computer resource does not automatically dictate that all requests will be sorted on a monetary priority basis.

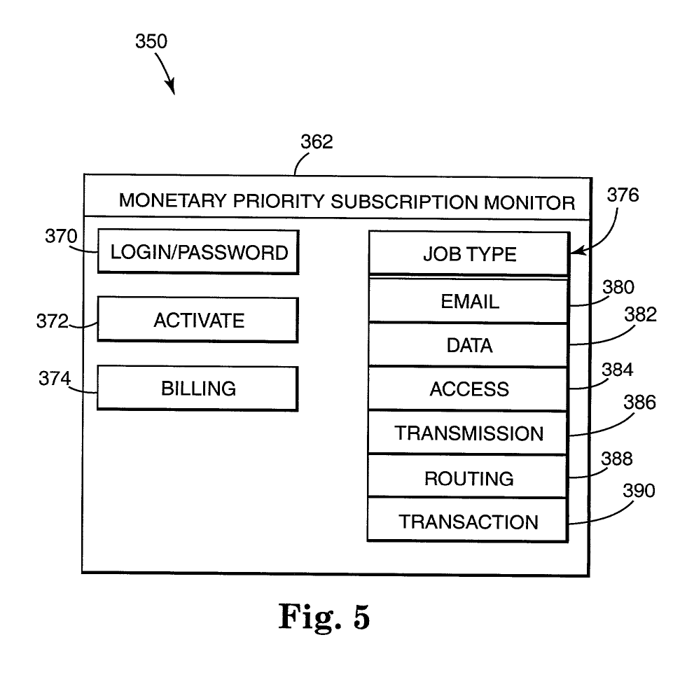

As shown in FIG. 5, monetary priority subscription monitor 360 includes user interface 362, login/password function 370, activation function 372, billing function 374, and job type function 376. Job type function 376 includes a listing of selectable job type priority designations 377 including email 380, data 384, access 384, transmission 386, routing 388, and transaction 390.

Monitor 360 can be used by a subscriber and/or a throughput resource to manage monetary priority designations 22, 162, 322 and/or operation of monetary priority scheduler queues 30, 170, 322. Login/password function 370 prevents unauthorized entities from accessing monitor 360. Activation function 372 permits activating and deactivating monetary priority designations 22, 162, 322 and/or monetary priority scheduler queues 30, 170, 322. Billing function 374 allows subscribers 12 and/or throughput resources 14 to manage account payment and usage. Finally, job type function 376 allows subscriber 12 and/or throughput resource 14 to provide even greater preference for select job types submitted by a subscriber. Preferred subscribers with monetary-based job type designations 377 would receive priority request handling for only those job types having a priority designation. Alternatively, preferred subscriber 12 with job type priority designations 377 would receive priority request handling with an even greater priority than preferred subscribers that do not have monetary-based job type priority designations. Finally, these job type priority designations are preferably established in association with step 104 of method 100 (FIG. 2).

A system and method of handling resource requests of the present invention carries numerous advantageous features. Foremost, subscribers can pay for performance to have their requests handled faster by paying money to placed higher in a request queue than non-paying or lower-paying subscribers. The system and method of the present invention can be deployed in any network setting, although is especially well-suited for internet networks where extreme competition for computer resources plagues every aspect of communication. Finally, the monetary priority scheduler queue in the method and system of the present invention can be applied anywhere in a chain of network communication, not just between a user and a web server, or between a user and an internet service provider.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of prioritizing computer resource requests, the method comprising:
receiving a first resource request at a throughput resource from a preferred subscriber having a monetary priority designation; and
processing the resource request from the preferred subscriber prior to processing a second resource request from a non-preferred subscriber having a non-monetary priority designation.

2. The method of claim 1 wherein the processing step further comprises:
transmitting the first resource request to a job resource configured for performing the resource request.

3. The method of claim 1 and further comprising:
establishing an internet service provider as the preferred subscriber and an internet router as the throughput resource.

4. The method of claim 1 and further comprising:
establishing a client as the preferred subscriber and an internet service provider as the throughput resource.

5. The method of claim 1 and further comprising:
establishing a web browser as the preferred subscriber and a web server as the throughput resource.

6. The method of claim 5 and further comprising:
providing the web server as a service provider configured for performing a transaction for the web browser.

7. The method of claim 1 and further comprising:
providing the throughput resource as a server system configured for acting as at least one of the following computer resources:
web resource, file resource, printer, network resource, load leveler, router, hub, data resource, transaction resource, access resource, transmission resource, authorization resource, and stock trader.

8. The method of claim 1 and further comprising:
providing the throughput resource as at least one of a local area network, a internet access/service provider, a router, and a server, each having a monetary priority scheduler queue.

9. The method of claim 1 and further comprising:
providing the preferred subscriber as at least one of a local area network, a internet access/service provider, and a router, each having a monetary priority designation.

10. The method of claim 1 and further comprising:
prioritizing resource requests based on a job type monetary priority designation associated with at least one of the following job types:
email, data, access, transmission, routing, and transactions.

11. A method of handling job requests on a monetary priority basis comprising:
establishing a priority designation for each subscriber based on a relationship with a throughput resource including at least one of a monetary priority designation and a non-monetary priority designation;
receiving a job request from the subscriber at the throughput resource;
identifying the priority designation associated with the job request; and
scheduling the job request in a queue based on the priority designation with job requests having a monetary priority designation being performed prior to job requests having a non-monetary priority designation.

12. A priority resource request handling system comprising:
a first subscriber having a first monetary priority designation and a second subscriber having a second monetary priority designation; and
a throughput resource having a priority scheduling queue configured for handling resource requests of the first subscriber prior to handling resource requests of the second subscribers based on their respective monetary priority designations.

13. The system of claim 12 wherein the queue of the throughput resource comprises:
an input and output queue configured for handling both input and output resource requests on a monetary priority basis.

14. The system of claim 12 and further comprising:
a job resource for performing the resource request.

15. The system of claim 12 wherein the throughput resource is configured to perform at least one of a communication request, a data transmission request, a network communication routing request, and a network access request.

16. A pay for performance prioritized internet communication system comprising:
a preferred web browser configured to have a monetary priority designation; and
an internet service provider configured to act as a throughput resource including a queue for processing requests from the preferred web browser prior to processing other requests in the queue that lack a monetary priority designation.

17. The system of claim 16 and further comprising:
a local area network configured to act as a throughput resource for the preferred web browser and as a preferred subscriber to the internet service provider.

18. The system of claim 16 and further comprising:
a router configured to act as a second throughput resource on a monetary priority basis for the web browser; and
a server configured to act as a throughput resource on a monetary priority basis for the router.

19. The system of claim 16 and further comprising:
a server configured to act as a second throughput resource on a monetary priority basis for the web browser.

20. The system of claim 16 and further comprising:
a service provider configured to act as a preferred subscriber and a router configured to act as the throughput resource on a monetary prior basis for the internet service provider.

21. A monetary prioritized network communication system comprising:
a plurality of computer resources including:
a web browser;
a local area network;
an internet service provider;
a router; and a server,
wherein each computer resource is configured to act as a preferred subscriber to a throughput resource and to hold a monetary priority designation and wherein each of the local area network, the internet service provider, the router and the server are configured to act as the throughput resource relative to a subscriber and have a queue configured for prioritizing computer resource requests on a monetary priority basis using the monetary priority designations of the subscribers.

22. The system of claim 21 and further comprising:
a subscriber link for maintaining a monetary contractual relationship between one of the subscribers and one of the throughput resources.

23. A monetary priority subscription monitor comprising:
a graphical user interface including:
an activation function;
a login function; and
a job type priority designation function configured for managing monetary priority designations for at least one of the following job types:
email, data, access, transmission, routing, and transactional.

24. A computer-readable medium having computer-executable instructions for performing a method of monetarily prioritizing computer resource requests, the method comprising:
receiving a resource request at a throughput resource from a preferred subscriber having a monetary priority designation; and
processing the resource request from the preferred subscriber prior to processing a resource request from a non-preferred subscriber having a non-monetary priority designation.

25. The medium of claim 24 wherein the method further comprises:
providing the throughput resource as a server system configured for acting as at least one of the following computer resources: web resource, file resource, printer, network resource, load leveler, router, hub, data resource, transaction resource, access resource, transmission resource, authorization resource, and stock trader.

26. The medium of claim 24 wherein the method further comprises:
providing the throughput resource as at least one of a local area network, a internet access/service provider, a router, and a server, each having a monetary priority scheduler queue.

27. A computer-readable medium having computer-executable instructions for performing a method of handling resource requests on a monetary priority basis, the method comprising:
establishing a priority designation for each subscriber based on a relationship with a throughput resource including at least one of a monetary priority designation and a non-monetary priority designation;
receiving a job request from the subscriber at the throughput resource;
identifying the priority designation associated with the job request; and
scheduling the job request in a queue based on the priority designation with job requests having a monetary priority designation being performed prior to job requests having a non-monetary priority designation.
